(19) United States
(12) Patent Application Publication
(10) Pub. No.: US 2025/0344087 A1
(43) Pub. Date: Nov. 6, 2025

(54) MEDIUM ACCESS CONTROL CONTROL ELEMENT FOR MINIMIZATION OF DRIVE TEST OR QUALITY OF EXPERIENCE

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US); Mukesh Kumar MITTAL, San Diego, CA (US); Manish TRIPATHI, San Diego, CA (US)

(21) Appl. No.: 18/654,542

(22) Filed: May 3, 2024

(51) Int. Cl. H04W 24/10

(52) U.S. Cl. CPC H04W 24/10

(57) ABSTRACT

Various aspects of the present disclosure generally relate to wireless communication. Some aspects more specifically relate to medium access control (MAC) control element (MAC-CE)-based minimization of drive test (MDT) or quality of experience (QoE) measurement reporting. In some aspects, a central unit (CU) may transmit, to a user equipment (UE), a configuration that configures the UE to transmit MIDT or QoE measurements in MAC-CEs. In some aspects, the UE may transmit, to a distributed unit (DU), the MAC-CE carrying the one or more MDT or QoE measurements.

### FIELD OF THE DISCLOSURE

Aspects of the present disclosure generally relate to wireless communication and specifically relate to techniques, apparatuses, and methods associated with medium access control (MAC) control elements for minimization of drive test or quality of experience.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

A user equipment (UE) may report minimization of drive test (MDT) and/or quality of experience (QoE) measurements to a central unit (CU) of a network node using radio resource control (RRC) signaling, and the CU may transfer the MDT measurements and/or QoE measurements to a distributed unit (DU) of a network node, which may perform a networking action based at least in part on the MDT measurements and/or QoE measurements. Because the CU and the DU are separated, the MDT measurements and/or QoE measurements may experience a latency between the CU and the DU, which may delay the networking action performed by the DU. Furthermore, the transfer of the MDT measurements and/or QoE measurements from the CU to the DU may increase signaling overhead between the CU and the DU.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to transmit a UE capability indicating that the UE is capable of carrying minimization of drive test (MDT) or quality of experience (QoE) measurements in medium access control (MAC) control elements (MAC-CEs). At least one processor of the one or more processors may be configured to cause the UE to receive, in accordance with the UE capability, a MAC-CE MDT or QoE configuration. At least one processor of the one or more processors may be configured to cause the UE to transmit, in accordance with the MAC-CE MDT or QoE configuration, a MAC-CE carrying one or more MDT or QoE measurements.

Some aspects described herein relate to an apparatus for wireless communication at a network node. The apparatus may include one or more memories storing processor-executable code and one or more processors coupled with the one or more memories. At least one processor of the one or more processors may be configured to cause the network node to receive a UE capability indicating that a UE is capable of carrying MDT or QoE measurements in MAC-CEs. At least one processor of the one or more processors may be configured to cause the network node to transmit, in accordance with the UE capability, a MAC-CE MDT or QoE configuration. At least one processor of the one or more processors may be configured to cause the network node to receive, in accordance with the MAC-CE MDT or QoE configuration, a MAC-CE carrying one or more MDT or QoE measurements.

Some aspects described herein relate to a method of wireless communication performed at a UE. The method may include transmitting a UE capability indicating that the UE is capable of carrying MDT or QoE measurements in MAC-CEs. The method may include receiving, in accordance with the UE capability, a MAC-CE MDT or QoE configuration. The method may include transmitting, in accordance with the MAC-CE MDT or QoE configuration, a MAC-CE carrying one or more MDT or QoE measurements.

Some aspects described herein relate to a method of wireless communication performed at a network node. The method may include receiving a user equipment (UE) capability indicating that a UE is capable of carrying MDT or QoE measurements in MAC-CEs. The method may include transmitting, in accordance with the UE capability, a MAC-CE MDT or QoE configuration. The method may include receiving, in accordance with the MAC-CE MDT or QoE configuration, a MAC-CE carrying one or more MDT or QoE measurements.

Some aspects described herein relate to a non-transitory computer-readable medium storing a set of instructions for wireless communication. The set of instructions may include one or more instructions that, when executed at a UE, cause the UE to transmit a UE capability indicating that the UE is capable of carrying MDT or QoE measurements in MAC-CEs. The set of instructions may include one or more instructions that, when executed at a UE, cause the UE to receive, in accordance with the UE capability, a MAC-CE MDT or QoE configuration. The set of instructions may include one or more instructions that, when executed at a UE, cause the UE to transmit, in accordance with the MAC-CE MDT or QoE configuration, a MAC-CE carrying one or more MDT or QoE measurements.

Some aspects described herein relate to a non-transitory computer-readable medium storing a set of instructions for wireless communication. The set of instructions may include one or more instructions that, when executed at a network node, cause the network node to receive a UE capability indicating that a UE is capable of carrying MDT or QoE measurements in MAC-CEs. The set of instructions may include one or more instructions that, when executed at a network node, cause the network node to transmit, in accordance with the UE capability, a MAC-CE MDT or QoE configuration. The set of instructions may include one or more instructions that, when executed at a network node, cause the network node to receive, in accordance with the MAC-CE MDT or QoE configuration, a MAC-CE carrying one or more MDT or QoE measurements.

Some aspects described herein relate to an apparatus for wireless communication. The apparatus may include means for transmitting a UE capability indicating that the UE is capable of carrying MDT or QoE measurements in MAC-CEs. The apparatus may include means for receiving, in accordance with the UE capability, a MAC-CE MDT or QoE configuration. The apparatus may include means for transmitting, in accordance with the MAC-CE MDT or QoE configuration, a MAC-CE carrying one or more MDT or QoE measurements.

Some aspects described herein relate to an apparatus for wireless communication. The apparatus may include means for receiving a UE capability indicating that a UE is capable of carrying MDT or QoE measurements in MAC-CEs. The apparatus may include means for transmitting, in accordance with the UE capability, a MAC-CE MDT or QoE configuration. The apparatus may include means for receiving, in accordance with the MAC-CE MDT or QoE configuration, a MAC-CE carrying one or more MDT or QoE measurements.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment (UE) in a wireless network.

FIG. 3 is a diagram illustrating an example associated with medium access control (MAC) control element (MAC-CE) based minimization of drive test (MDT) or quality of experience (QoE) reporting.

FIG. 4 is a flowchart illustrating an example process performed, for example, at a UE or an apparatus of a UE that supports MAC-CE-based MDT or QoE reporting.

FIG. 5 is a flowchart illustrating an example process performed, for example, at a network node or an apparatus of a network node that supports MAC-CE-based MDT or QoE reporting.

FIG. 6 is a diagram of an example apparatus, such as a UE, for wireless communication that supports MAC-CEs for MDT or QoE.

FIG. 7 is a diagram of an example apparatus, such as a network node, for wireless communication that supports MAC-CEs for MDT or QoE.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may report various types of measurements to a network node. For example, minimization of drive test (MDT) measurements may reduce a quantity of drive tests. A drive test may involve using a vehicle containing measurement equipment to measure wireless communication parameters at various locations within a wireless communication network. For example, parameters measured in drive test may include signal level, signal quality, interference, or quality of service (QoS), among other examples. Wireless carriers may use the results of the drive test to improve coverage of the wireless communication network. Multiple drive tests are often performed at various times and locations, which can be costly. MDT may reduce a quantity of drive tests by collecting measurements from UEs (for example, instead of during a drive test). Additionally or alternatively, quality of experience (QoE) measurements may be reported by UEs in a specified area or specific UE for a specified end user service and/or end user service type.

Thus, a UE may report MDT measurements and/or QoE measurements to a network node. For example, the UE may report MDT measurements and/or QoE measurements to a central unit (CU) of the network node using radio resource control (RRC) signaling, and the CU may transfer the MDT measurements and/or QoE measurements to a distributed unit (DU) (for example, a scheduler) of a network node, which may perform a networking action based at least in part on the MDT measurements and/or QoE measurements. Because the CU and the DU are separated, the MDT measurements and/or QoE measurements may experience a latency between the CU and the DU, which may delay the networking action performed by the DU. Furthermore, the transfer of the MDT measurements and/or QoE measurements from the CU to the DU may increase signaling overhead between the CU and the DU.

Various aspects relate generally to MAC-CEs that carry one or more MDT or QoE measurements. Some aspects more specifically relate to time-critical MAC-CE-based MDT or QoE measurement reporting. In some aspects, a CU may transmit, to a UE, a configuration that configures the UE to transmit MDT or QoE measurements in MAC-CEs. In some examples, the configuration may indicate one or more triggering condition parameters that the UE may use to identify when to transmit a MAC-CE that carries one or more MDT or QoE measurements. In some examples, the CU may transmit, to the UE, a request for the MAC-CE carrying the one or more MDT or QoE measurements. In some aspects, the UE may transmit, to a DU, the MAC-CE carrying the one or more MDT or QoE measurements. For example, the UE may transmit the MAC-CE based at least in part on the one or more triggering condition parameters or in response to receiving the request for the MAC-CE.

Particular aspects of the subject matter described in this disclosure can be implemented to realize one or more of the following potential advantages. In some examples, by carrying one or more MDT or QoE measurements in a MAC-CE, the described techniques can be used to avoid forwarding between the CU and the DU, thereby reducing latency. Thus, the DU may promptly take action based at least in part on the one or more MDT or QoE measurements. Furthermore, the MAC-CE carrying the one or more MDT or QoE measurements may help to reduce signaling overhead on an interface between the CU and the DU.

The configuration indicating the one or more triggering condition parameters may help the UE to autonomously identify when to transmit the MAC-CE, thereby avoiding additional signaling, and reducing overhead, between the CU and the UE.

The request for the MAC-CE may prompt the UE to transmit the MAC-CE and thereby reduce usage of memory and/or processing resources at the UE that would otherwise be allocated for identifying when to transmit the MAC-CE.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

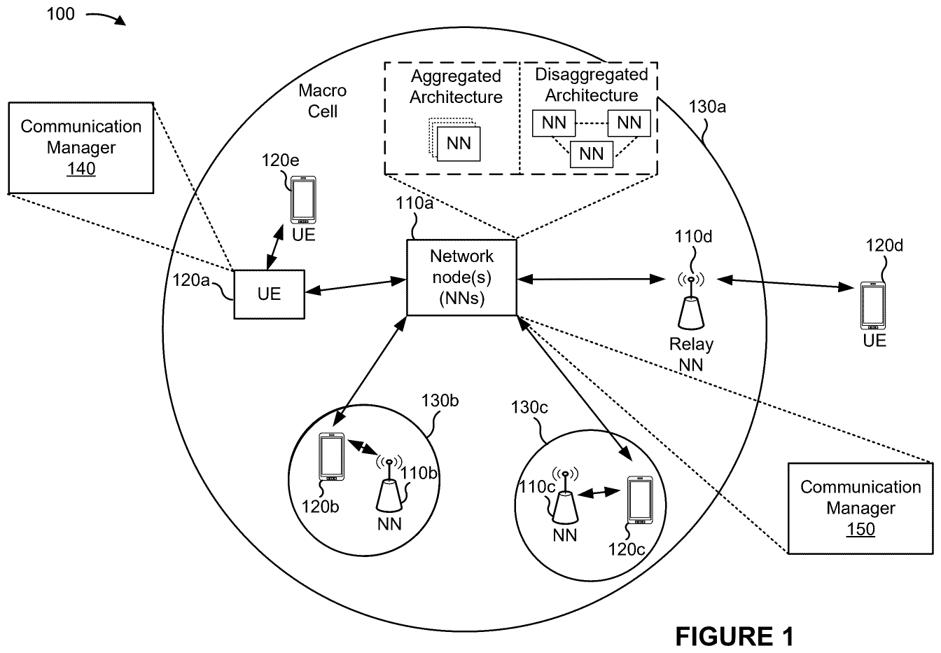

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long-Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more CUs, one or more DUs, and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication.

In some aspects, the UE 120 may include a communication manager 140. As described in more detail elsewhere herein, the communication manager 140 may transmit a UE capability indicating that the UE is capable of carrying MDT or QoE measurements in MAC-CEs; receive, in accordance with the UE capability, a MAC-CE MDT or QoE configuration; and transmit, in accordance with the MAC-CE MDT or QoE configuration, a MAC-CE carrying one or more MDT or QoE measurements. Additionally or alternatively, the communication manager 140 may perform one or more other operations described herein.

In some aspects, the network node 110 may include a communication manager 150. As described in more detail elsewhere herein, the communication manager 150 may receive a UE capability indicating that a UE is capable of carrying MDT or QoE measurements in MAC-CEs; transmit, in accordance with the UE capability, a MAC-CE MDT or QoE configuration; and receive, in accordance with the MAC-CE MDT or QoE configuration, a MAC-CE carrying one or more MDT or QoE measurements. Additionally or alternatively, the communication manager 150 may perform one or more other operations described herein.

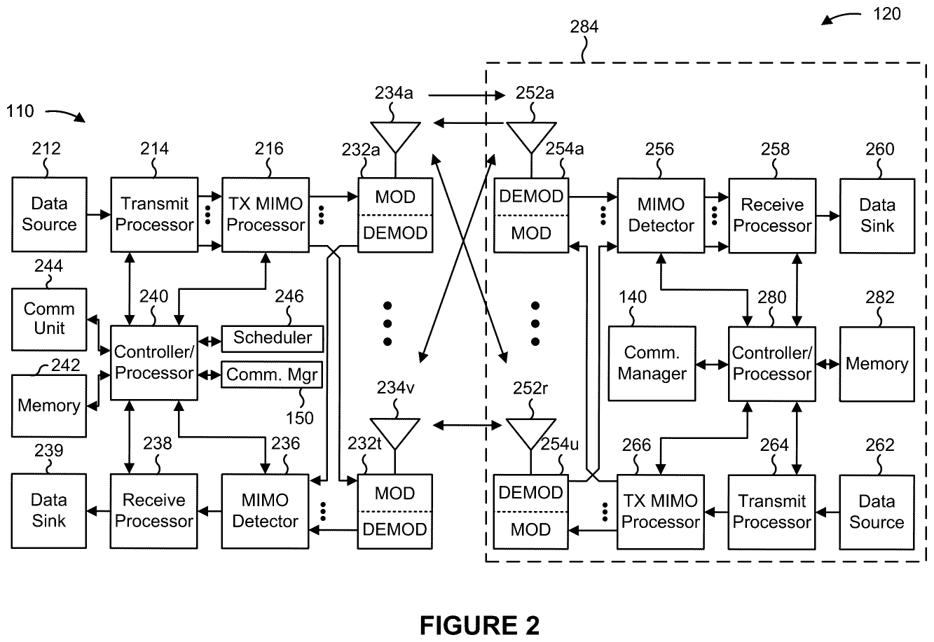

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor” or “a/the controller/processor,” among other examples (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use downlink control information (DCI) to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a uplink control information (UCI) communication, a MAC-CE communication, an RRC communication, or another type of uplink communication. Uplink signals may be transmitted on a physical uplink shared channel (PUSCH), a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

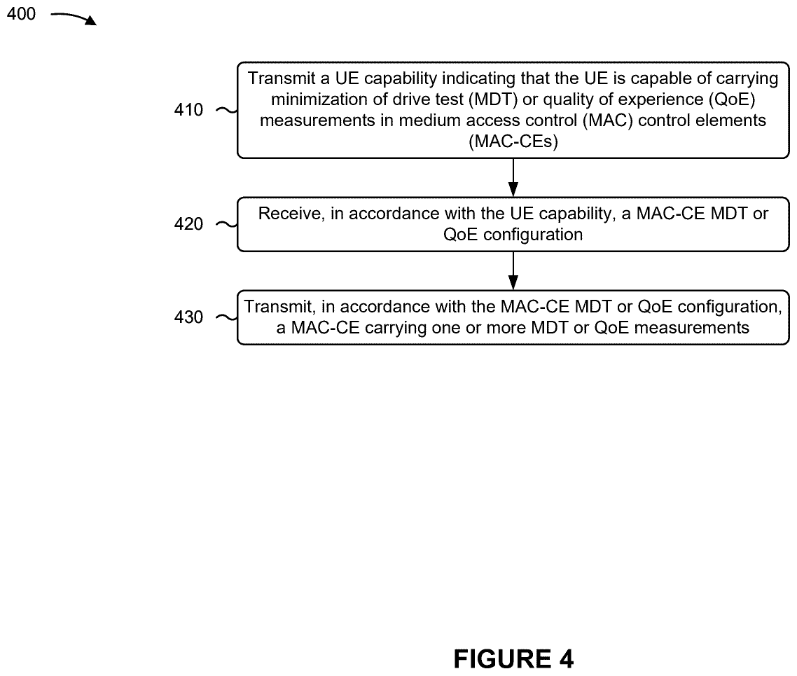

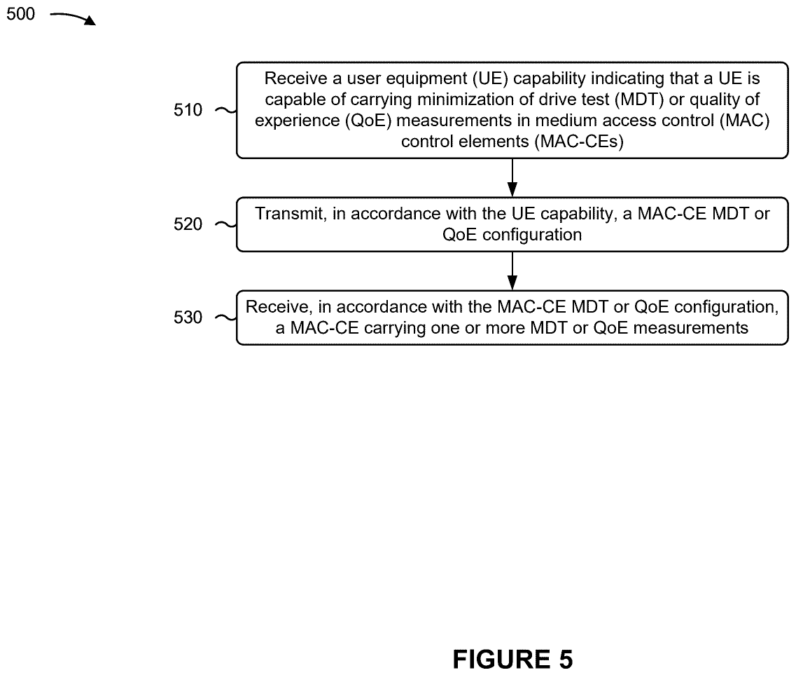

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with MAC-CEs for MDT or QoE, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 400 of FIG. 4, process 500 of FIG. 5, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 400 of FIG. 4, process 500 of FIG. 5, or other processes as described herein. In some examples, executing instructions may include running the instructions, converting the instructions, compiling the instructions, and/or interpreting the instructions, among other examples.

In some aspects, the UE 120 includes means for transmitting a UE capability indicating that the UE is capable of carrying MDT or QoE measurements in MAC-CEs; means for receiving, in accordance with the UE capability, a MAC-CE MDT or QoE configuration; and/or means for transmitting, in accordance with the MAC-CE MDT or QoE configuration, a MAC-CE carrying one or more MDT or QoE measurements. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving a UE capability indicating that a UE is capable of carrying MDT or QoE measurements in MAC-CEs; means for transmitting, in accordance with the UE capability, a MAC-CE MDT or QoE configuration; and/or means for receiving, in accordance with the MAC-CE MDT or QoE configuration, a MAC-CE carrying one or more MDT or QoE measurements. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

There are at least two modes for MDT measurements: logged MDT and immediate MDT. Logged MDT may involve measurements logged by UEs for reporting at a later point in time. In 4G, logged MDT may involve UEs RRC idle mode or periodic logging with location information, among other examples. In 5G, logged MDT may involve UEs in RRC inactive mode, event-based logging, beam information, or sensor information, among other examples.

Immediate MDT may involve measurements performed by UEs and reported at the time of a reporting condition. In 4G, immediate MDT may involve certain measurements, which may be referred to as measurements 1 through 9 (M1-M9), based at least in part on a radio resource management (RRM) procedure with extensions for location information. In 5G, immediate MDT may involve evolved non-standalone dual connectivity (EN-DC), beam information, average delay measurements, or sensor information, among other examples.

In some examples, MDT may involve accessibility measurements. In 4G, the accessibility measurements may include logging of failure of RRC setup or location information, among other examples. In 5G, the accessibility measurements may include beam information, random access channel (RACH) failure measurements, failure of resume measurements, or sensor information, among other examples.

In some examples, MDT may involve mobility robustness optimization (MRO) measurements. In 4G, the MRO measurements may include connection or handover failure measurements, radio link failure (RLF) measurements with location information, or intra-RAT reports, among other examples. In 5G, the MRO measurements may include beam failure recovery (BFR) or secondary cell group (SCG) failure, beam reports, cross-RAT reports, or sensor information, among other examples.

In some examples, MDT may involve RACH optimization measurements. In 4G, the RACH optimization measurements may include a single RACH report for a latest successful RACH procedure, among other examples. In 5G, the RACH optimization measurements may include multiple RACH reports or random access attempts over a beam, among other examples.

In some examples, MDT may involve mobility history measurements. In 4G, the mobility history measurements may include a visited cell list of an evolved universal mobile telecommunication system (UMTS) terrestrial radio access network (EUTRAN) or a mobility state (for example, low, medium, or high), among other examples. In 5G, the mobility history measurements may include a visited cell list of a EUTRAN or an NR network, among other examples.

In some examples, MDT may involve mobility load balancing measurements. In 4G, the mobility load balancing measurements may include a network node exchanging load information over an Xn interface, an X2 interface, an F1 interface, or an E1 interface, among other examples. In 5G, the mobility load balancing measurements may include a network node exchanging information including 5G metrics, such as beam information, among other examples.

Some examples may support enhanced data collection for MDT. For example, the data collection may involve UE reporting and inter-node information exchange via S1, NG, X2, Xn, F1, and/or E1 interfaces. In some examples, the data collection May be for one or more of the following (among other examples): two-step RACH optimization; successful handover reports; mobility history information in multi-RAT dual connectivity (MR-DC); on-demand system information (SI); optimization related to NR unlicensed (NR-U); MDT enhancements; MDT for MR-DC; layer 2 (L2) measurements for split bearers; mobility enhancements; capacity and coverage optimization (CCO); inter-system inter-RAT energy saving; inter-system load balancing; load balancing enhancements; MRO for secondary node (SN) change failure; or physical cell identifier (PCI) selection.

Some examples may support MDT enhancements for RACH enhancements, MR-DC conditional primary secondary cell (PScell) addition or change (CPAC) and MRO successful PScell change reports, successful handover (HO) reports, non-public networks (NPN), RACH reports, fast master cell group (MCG) recovery, NR-U (for example, MRO or uplink mobility load balancing (MLB), among other examples), among other examples. In some examples, signaling-based logged MDT override protection may address scenarios where the signaling-based MDT is configured in LTE, and the UE connects to the network using NR.

QoE measurements may be for one or more QoE metrics, such as representation switch events, average throughput, initial playout delay, buffer level, play list, media presentation description (MPD) information, playout delay for media start-up, device information, corruption duration, successive loss of real-time transport protocol (RTP) packets, frame rate, jitter duration, synchronization loss duration, round-trip time, average codec bitrate, or codec information, among other examples. The QoE measurements may be transported to a collection center for analysis and/or calculation of key performance indicators (KPIs).

Thus, a UE may report MDT measurements and/or QoE measurements to a network node. For example, the UE may report MDT measurements and/or QoE measurements to a CU of the network node using RRC signaling. For example, the UE may report MDT measurements to the CU via a signaling radio bearer (SRB). For example, the UE may report MDT measurements to the CU via SRB 1 or, if the CU is of a master node (MN) or an SN, then via SRB 4 or SRB 5. In some examples, the CU may transfer the MDT measurements and/or QoE measurements to a DU (for example, a scheduler) of the network node, which may perform a networking action based at least in part on the MDT measurements and/or QoE measurements.

Because the CU and the DU are separated, the MDT measurements and/or QoE measurements may experience a latency between the CU and the DU. The latency may delay the networking action performed by the DU. For example, if the MDT measurements and/or QoE measurements indicate KPI or QoE degradation, then the latency may prevent the DU from quickly taking action to prevent the KPI or QoE degradation. Furthermore, the transfer of the MDT measurements and/or QoE measurements from the CU to the DU may introduce high signaling overhead between the CU and the DU (for example, in an F1 interface between the CU and the DU).

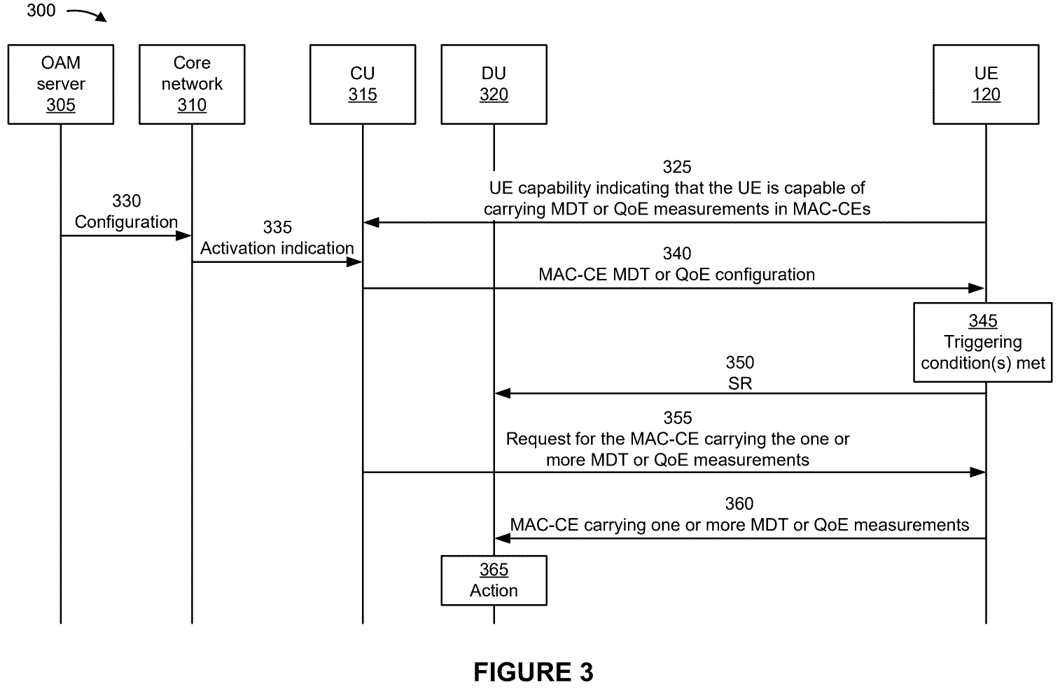

FIG. 3 is a diagram illustrating an example 300 associated with MAC-CE-based MDT or QoE reporting. As shown in FIG. 3, an operations, administration, and management (OAM) server 305, a core network 310, a CU 315, a DU 320, and a UE 120 may communicate with one another. The core network 310 may be a 5G core network or a 6G core network, among other examples. In some examples, the CU 315 may be of a network node 110. In some examples, the DU 320 may be of the network node 110.

In a first operation 325, the UE 120 may transmit, and the CU 315 may receive, a UE capability indicating that the UE 120 is capable of carrying MDT or QoE measurements in MAC-CEs. For example, the UE capability may indicate that the UE 120 is capable of carrying MAC-CE-based timing-critical MDT or QoE measurements. For example, the UE capability may be referred to as a timing-critical MAC-CE-based MDT or QoE UE capability.

In a second operation 330, the OAM server 305 may transmit, and the core network 310 may receive, a MAC-CE-based MDT or QoE configuration. The MAC-CE-based MDT or QoE configuration may be a MAC-CE-based timing-critical MDT or QoE configuration that configures the core network 310 for MAC-CE-based timing-critical MDT or QoE measurements.

In a third operation 335, the core network 310 may transmit, and the CU 315 may receive, an indication to activate a MAC-CE MDT or QoE functionality. For example, the indication may indicate the core network 310 to activate a time-critical MAC-CE MDT or QoE functionality. The core network 310 may transmit the indication to activate the MAC-CE MDT or QoE functionality responsive to the MAC-CE-based MDT or QoE configuration.

In a fourth operation 340, the CU 315 may transmit, and the UE 120 may receive, in accordance with the UE capability, a MAC-CE MDT or QoE configuration. For example, the MAC-CE MDT or QoE configuration may configure the UE 120 to carry MDT or QoE measurements in MAC-CEs. In some examples, the MAC-CE MDT or QoE configuration may configure MAC-CE-based MDT or QoE measurements via RRC signaling. For example, the MAC-CE MDT or QoE configuration may be an RRC reconfiguration for timing-critical MDT or QoE. The CU 315 may transmit the MAC-CE MDT or QoE configuration responsive to receiving the indication to activate the MAC-CE MDT or QoE functionality and based at least in part on the UE capability.

In some aspects, the MAC-CE MDT or QoE configuration may indicate one or more triggering condition parameters associated with a MAC-CE carrying the one or more MDT or QoE measurements. The one or more triggering condition parameters may be associated with the MAC-CE in that the UE 120 may identify when one or more triggering conditions that prompt the UE 120 to transmit the MAC-CE have been met using the one or more triggering condition parameters. For example, the one or more triggering condition parameters may define events and/or event trigger conditions for timing-critical MDT or QoE measurements.

In some aspects, the one or more triggering condition parameters may include a physical downlink shared channel (PDSCH) discard rate threshold associated with one or more hybrid automatic repeat request (HARQ) acknowledgment (ACK) or negative ACK (NACK) feedback errors. The PDSCH discard rate threshold may be associated with the one or more HARQ ACK or NACK feedback errors in that the PDSCH discard rate threshold may be satisfied due to the one or more HARQ ACK or NACK feedback errors. For example, the UE 120 may receive a PDSCH communication over a high-quality downlink and transmit HARQ ACK or NACK feedback over an uplink. If the uplink is low-quality, then the network node 110 may not receive the HARQ ACK or NACK feedback and retransmit the PDSCH communication that the UE 120 receives and discards. The UE 120 may continue to discard PDSCH communications due to the quality imbalance of the uplink and downlink. The rate at which the UE 120 discards the PDSCH communications may be referred to as a PDSCH discard rate. The PDSCH discard rate satisfying (for example, exceeding) the PDSCH discard rate threshold may be a triggering condition that prompts the UE 120 to transmit the MAC-CE.

In some aspects, the one or more triggering condition parameters may include a MAC padding threshold. For example, the UE 120 may use resources allocated by a grant to transmit data, and resources allocated by the grant that are not used to transmit the data may contain MAC padding. As the inefficiency of the scheduler increases (for example, in cases where the DU 320 provides excessive grants to the UE 120), the quantity of MAC padding may increase. The quantity of MAC padding satisfying (for example, exceeding) the MAC padding threshold may be a triggering condition that prompts the UE 120 to transmit the MAC-CE.

In some aspects, the one or more triggering condition parameters may include a data stall threshold. For example, data stall may occur in cases where the UE 120 obtains insufficient scheduling or in cases involving excessive block error rate (BLER). The data stall satisfying (for example, exceeding) the data stall threshold may be a triggering condition that prompts the UE 120 to transmit the MAC-CE.

In some aspects, the one or more triggering condition parameters may include a QoE threshold associated with an application. The QoE threshold may be associated with the application in that QoE for the application may be compared to the QoE threshold. For example, the QoE satisfying (for example, falling below) the QoE threshold may be a triggering condition that prompts the UE 120 to transmit the MAC-CE.

In the fifth operation 345, the UE 120 may identify that one or more of the triggering conditions have been met. The triggering condition(s) may be poor RF, poor user experience, or a specific event, among other examples. For example, the UE 120 may identify that the PDSCH discard rate satisfies the PDSCH discard rate threshold, the quantity of MAC padding satisfies the MAC padding threshold, the data stall satisfies the data stall threshold, or the QoE satisfies the QoE threshold, among other examples. In some examples, the one or more triggering conditions may be timing-critical MDT or QoE triggering conditions. The UE 120 identifying that a triggering condition has been met may be referred to as event-triggered MDT or QoE.

In a sixth operation 350, the UE 120 may transmit, and the DU 320 may receive, in accordance with an uplink grant not being associated with the MAC-CE carrying the one or more MDT or QoE measurements, a scheduling request (SR) associated with the MAC-CE carrying the one or more MDT or QoE measurements. The SR may be associated with the MAC-CE in that the SR may be a request to schedule the MAC-CE. An uplink grant may not be associated with the MAC-CE in that the UE 120 may not have received an uplink grant that the UE 120 can use to transmit the MAC-CE.

In the seventh operation 355, the CU 315 may transmit, and the UE 120 may receive, via another MAC-CE or physical downlink control channel (PDCCH) DCI, a request for the MAC-CE carrying the one or more MDT or QoE measurements. The seventh operation 355 may be alternative to the fifth operation 345. For example, either the fifth operation 345 or the seventh operation 355 may prompt the UE 120 to transmit the MAC-CE carrying one or more MDT or QoE measurements. In some examples, the CU 315 may transmit the request for the MAC-CE carrying the one or more MDT or QoE measurements in addition to indicating the one or more triggering condition parameters in the MAC-CE or QoE configuration as shown in the fourth operation 340. In some examples, the CU 315 may transmit the request for the MAC-CE carrying the one or more MDT or QoE measurements without indicating the one or more triggering condition parameters in the MAC-CE or QoE configuration as shown in the fourth operation 340. The request may be a timing-critical MDT or QoE request that is carried via MAC-CE or DCI. For example, the CU 315 may dynamically and/or directly request the UE 120 to report the one or more MDT or QoE measurements. In some examples, the CU 315 may request the UE 120 to report the one or more MDT or QoE measurements based at least in part on network-side prediction (for example, using AI/ML) or detection of RLF or QoE degradation, among other examples.

In an eighth operation 360, the UE 120 may transmit, and the DU 320 may receive, the MAC-CE carrying one or more MDT or QoE measurements. For example, the UE 120 may transmit the MAC-CE carrying the one or more MDT or QoE measurements responsive to the identifying that one or more of the triggering conditions have been met in the fifth operation 345 or responsive to receiving the request for the MAC-CE carrying the one or more MDT or QoE measurements in the seventh operation 355. In some examples, the MAC-CE may carry timing-critical MDT or QoE measurements on a PUSCH. Thus, the UE 120 may provide MAC-CE-based timing-critical MDT or QoE measurements to the DU 320 (for example, the scheduler). For example, the UE 120 may directly report the timing-critical MDT or QoE measurements to the DU 320 via the MAC-CE.

In some aspects, the MAC-CE may further carry an indication of one or more candidate root causes associated with the one or more MDT or QoE measurements. The one or more candidate root causes may be associated with the one or more MDT or QoE measurements in that the one or more candidate root causes may impact the one or more MDT or QoE measurements. For example, the UE 120 may report the one or more MDT or QoE measurements with one or more candidate root causes via MAC-CE to DU. The one or more candidate root causes may be possible RAN-related issues, such as the quality imbalance of the uplink and downlink, excessive grants, insufficient scheduling, or excessive BLER, among other examples.

In some aspects, the MAC-CE may further carry an indication of a resolution time associated with the one or more MDT or QoE measurements. The resolution time may be associated with the one or more MDT or QoE measurements in that the resolution time may be a maximum time by which the DU 320 is to take action to improve subsequent MDT or QoE measurements. For example, the resolution time may be a deadline that the UE 120 reports to the DU 320 with the one or more MDT or QoE measurements via the MAC-CE.

In some aspects, the MAC-CE may further carry an indication of one or more candidate actions associated with the one or more MDT or QoE measurements. The one or more candidate actions may be associated with the one or more MDT or QoE measurements in that the one or more candidate actions might, if taken, help to improve subsequent MDT or QoE measurements. The candidate actions may include adjusting the scheduler or load-balancing on a different carrier and/or RAT, among other examples. The candidate actions may be possible recommended actions that the UE 120 reports to the DU 320 with the one or more MDT or QoE measurements via the MAC-CE.

The MAC-CE carrying the indication of the one or more candidate root causes, the indication of the resolution time, and/or the indication of the one or more candidate actions may be examples of UE-assisted MDT or QoE. For example, the UE 120 may use AI/ML to detect poor user experience, identify possible causes of the issue(s), and provide recommended solution(s) to the issue(s) and/or a time within which to resolve the issue(s).

In a ninth operation 365, the DU 320 may take an action to improve subsequent MDT or QoE measurements. For example, the action may prevent KPI or QoE degradation. The DU 320 may take the action immediately (or near-immediately) after receiving the MAC-CE. In some examples, the action may be based at least in part on the one or more MDT or QoE measurements, the one or more candidate root causes, resolution time, or the one or more candidate actions, among other examples. For example, the DU 320 may, within the resolution time, adjust the scheduler or load-balance on the different carrier and/or RAT, among other examples.

The MAC-CE carrying the one or more MDT or QoE measurements (for example, timing-critical MDT or QoE measurements) may help to enable the one or more MDT or QoE measurements that are directedly reported to the DU 320 (and/or an MN scheduler or an SN scheduler, among other examples). As a result, the one or more MDT or QoE measurements may avoid forwarding between the CU 315 and the DU 320 (and/or an MN and an SN), thereby reducing latency. Thus, the DU 320 may detect or identify root causes and/or take action (for example, immediate or near-immediate action) to prevent KPI and/or QoE degradation by fixing issues (for example, a RAN or user experience issue) in real-time. As a result, user experience may be improved for XR and/or other services. Furthermore, the MAC-CE carrying the one or more MDT or QoE measurements may help to reduce signaling overhead on an interface (for example, the F1 interference) between the CU 315 and the DU 320.

The MAC-CE MDT or QoE configuration indicating the one or more triggering condition parameters may help the UE 120 to autonomously identify when to transmit the MAC-CE, thereby reducing overhead between the CU 315 and the UE 120.

The request for the MAC-CE carrying the one or more MDT or QoE measurements may prompt the UE 120 to transmit the MAC-CE and thereby reduce usage of memory and/or processing resources at the UE 120.

FIG. 4 is a flowchart illustrating an example process 400 performed, for example, at a UE or an apparatus of a UE that supports MAC-CE-based MDT or QoE reporting. Example process 400 is an example where the apparatus or the UE (for example, UE 120) performs operations associated with MAC-CEs for MDT or QoE.

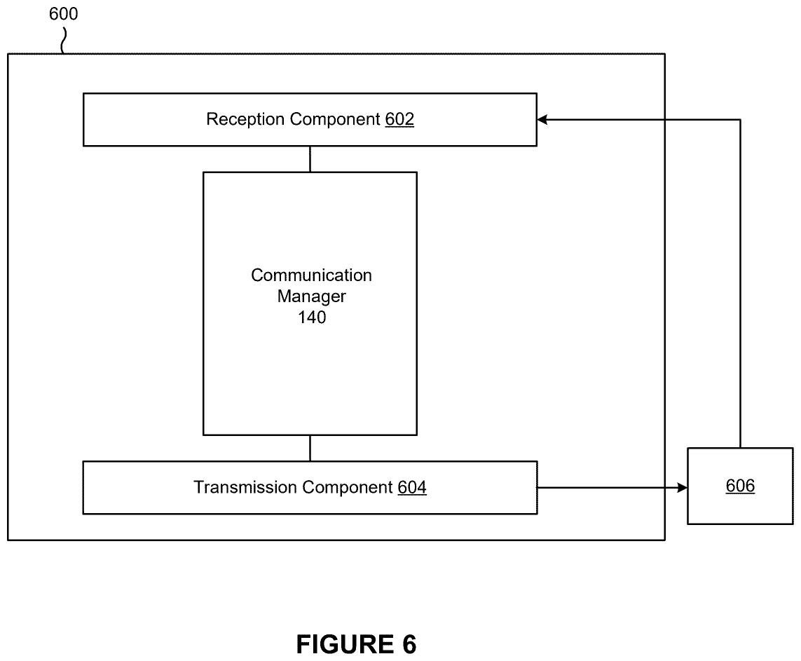

As shown in FIG. 4, in some aspects, process 400 may include transmitting a UE capability indicating that the UE is capable of carrying MDT or QoE measurements in MAC-CEs (block 410). For example, the UE (such as by using communication manager 140 or transmission component 604, depicted in FIG. 6) may transmit a UE capability indicating that the UE is capable of carrying MDT or QoE measurements in MAC-CEs, as described above.

As further shown in FIG. 4, in some aspects, process 400 may include receiving, in accordance with the UE capability, a MAC-CE MDT or QoE configuration (block 420). For example, the UE (such as by using communication manager 140 or reception component 602, depicted in FIG. 6) may receive, in accordance with the UE capability, a MAC-CE MDT or QoE configuration, as described above.

As further shown in FIG. 4, in some aspects, process 400 may include transmitting, in accordance with the MAC-CE MDT or QoE configuration, a MAC-CE carrying one or more MDT or QoE measurements (block 430). For example, the UE (such as by using communication manager 140 or transmission component 604, depicted in FIG. 6) may transmit, in accordance with the MAC-CE MDT or QoE configuration, a MAC-CE carrying one or more MDT or QoE measurements, as described above.

Process 400 may include additional aspects, such as any single aspect or any combination of aspects described below or in connection with one or more other processes described elsewhere herein.

In a first additional aspect, the MAC-CE MDT or QoE configuration indicates one or more triggering condition parameters associated with the MAC-CE carrying the one or more MDT or QoE measurements.

In a second additional aspect, alone or in combination with the first aspect, the one or more triggering condition parameters include a PDSCH discard rate threshold associated with one or more HARQ ACK or NACK feedback errors.

In a third additional aspect, alone or in combination with one or more of the first and second aspects, the one or more triggering condition parameters include a MAC padding threshold.

In a fourth additional aspect, alone or in combination with one or more of the first through third aspects, the one or more triggering condition parameters include a data stall threshold.

In a fifth additional aspect, alone or in combination with one or more of the first through fourth aspects, the one or more triggering condition parameters include a QoE threshold associated with an application.

In a sixth additional aspect, alone or in combination with one or more of the first through fifth aspects, process 400 includes transmitting, in accordance with an uplink grant not being associated with the MAC-CE carrying the one or more MDT or QoE measurements, an SR associated with the MAC-CE carrying the one or more MDT or QoE measurements.

In a seventh additional aspect, alone or in combination with one or more of the first through sixth aspects, process 400 includes receiving, via another MAC-CE or PDCCH DCI, a request for the MAC-CE carrying the one or more MDT or QoE measurements.

In an eighth additional aspect, alone or in combination with one or more of the first through seventh aspects, the MAC-CE further carries an indication of one or more candidate root causes associated with the one or more MDT or QoE measurements.

In a ninth additional aspect, alone or in combination with one or more of the first through eighth aspects, the MAC-CE further carries an indication of a resolution time associated with the one or more MDT or QoE measurements.

In a tenth additional aspect, alone or in combination with one or more of the first through ninth aspects, the MAC-CE further carries an indication of one or more candidate actions associated with the one or more MDT or QoE measurements.

Although FIG. 4 shows example blocks of process 400, in some aspects, process 400 may include additional blocks, fewer blocks, different blocks, or differently arranged blocks than those depicted in FIG. 4. Additionally or alternatively, two or more of the blocks of process 400 may be performed in parallel.

FIG. 5 is a flowchart illustrating an example process 500 performed, for example, at a network node or an apparatus of a network node that supports MAC-CE-based MDT or QoE reporting. Example process 500 is an example where the apparatus or the network node (for example, network node 110) performs operations associated with MAC-CEs for MDT or QoE.

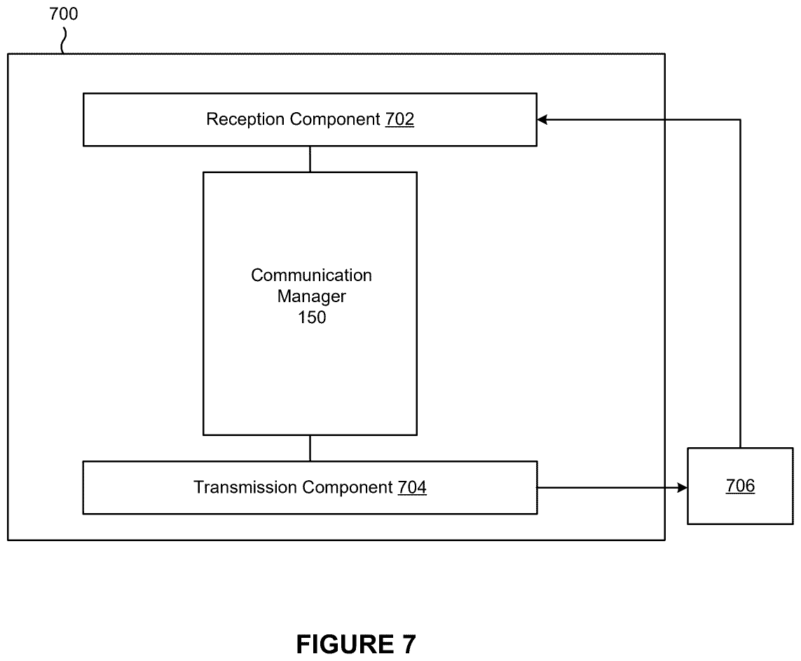

As shown in FIG. 5, in some aspects, process 500 may include receiving a UE capability indicating that a UE is capable of carrying MDT or QoE measurements in MAC-CEs (block 510). For example, the network node (such as by using communication manager 150 or reception component 702, depicted in FIG. 7) may receive a UE capability indicating that a UE is capable of carrying MDT or QoE measurements in MAC-CEs, as described above.

As further shown in FIG. 5, in some aspects, process 500 may include transmitting, in accordance with the UE capability, a MAC-CE MDT or QoE configuration (block 520). For example, the network node (such as by using communication manager 150 or transmission component 704, depicted in FIG. 7) may transmit, in accordance with the UE capability, a MAC-CE MDT or QoE configuration, as described above.

As further shown in FIG. 5, in some aspects, process 500 may include receiving, in accordance with the MAC-CE MDT or QoE configuration, a MAC-CE carrying one or more MDT or QoE measurements (block 530). For example, the network node (such as by using communication manager 150 or reception component 702, depicted in FIG. 7) may receive, in accordance with the MAC-CE MDT or QoE configuration, a MAC-CE carrying one or more MDT or QoE measurements, as described above.

Process 500 may include additional aspects, such as any single aspect or any combination of aspects described below or in connection with one or more other processes described elsewhere herein.

In a first additional aspect, the MAC-CE MDT or QoE configuration indicates one or more triggering condition parameters associated with the MAC-CE carrying the one or more MDT or QoE measurements.

In a second additional aspect, alone or in combination with the first aspect, the one or more triggering condition parameters include a PDSCH discard rate threshold associated with one or more HARQ ACK or NACK feedback errors.

In a third additional aspect, alone or in combination with one or more of the first and second aspects, the one or more triggering condition parameters include a MAC padding threshold.

In a fourth additional aspect, alone or in combination with one or more of the first through third aspects, the one or more triggering condition parameters include a data stall threshold.

In a fifth additional aspect, alone or in combination with one or more of the first through fourth aspects, the one or more triggering condition parameters include a QoE threshold associated with an application.

In a sixth additional aspect, alone or in combination with one or more of the first through fifth aspects, process 500 includes receiving, in accordance with an uplink grant not being associated with the MAC-CE carrying the one or more MDT or QoE measurements, an SR associated with the MAC-CE carrying the one or more MDT or QoE measurements.

In a seventh additional aspect, alone or in combination with one or more of the first through sixth aspects, process 500 includes receiving, via another MAC-CE or PDCCH DCI, a request for the MAC-CE carrying the one or more MDT or QoE measurements.

In an eighth additional aspect, alone or in combination with one or more of the first through seventh aspects, the MAC-CE further carries an indication of one or more candidate root causes associated with the one or more MDT or QoE measurements.

In a ninth additional aspect, alone or in combination with one or more of the first through eighth aspects, the MAC-CE further carries an indication of a resolution time associated with the one or more MDT or QoE measurements.

In a tenth additional aspect, alone or in combination with one or more of the first through ninth aspects, the MAC-CE further carries an indication of one or more candidate actions associated with the one or more MDT or QoE measurements.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a diagram of an example apparatus 600 for wireless communication that supports MAC-CEs for MDT or QoE. The apparatus 600 may be a UE, or a UE may include the apparatus 600. In some aspects, the apparatus 600 includes a reception component 602, a transmission component 604, and a communication manager 140, which may be in communication with one another (for example, via one or more buses). As shown, the apparatus 600 may communicate with another apparatus 606 (such as a UE, a network node, or another wireless communication device) using the reception component 602 and the transmission component 604.

In some aspects, the apparatus 600 may be configured to and/or operable to perform one or more operations described herein in connection with FIG. 3. Additionally or alternatively, the apparatus 600 may be configured to and/or operable to perform one or more processes described herein, such as process 400 of FIG. 4. In some aspects, the apparatus 600 may include one or more components of the UE described above in connection with FIG. 2.

The reception component 602 may receive communications, such as reference signals, control information, and/or data communications, from the apparatus 606. The reception component 602 may provide received communications to one or more other components of the apparatus 600, such as the communication manager 140. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 602 may include one or more antennas, one or more modems, one or more demodulators, one or more MIMO detectors, one or more receive processors, one or more controllers/processors, and/or one or more memories of the UE described above in connection with FIG. 2.

The transmission component 604 may transmit communications, such as reference signals, control information, and/or data communications, to the apparatus 606. In some aspects, the communication manager 140 may generate communications and may transmit the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 604 may be co-located with the reception component 602 in one or more transceivers.

The communication manager 140 may transmit or may cause the transmission component 604 to transmit a UE capability indicating that the UE is capable of carrying MDT or QoE measurements in MAC-CEs. The communication manager 140 may receive or may cause the reception component 602 to receive, in accordance with the UE capability, a MAC-CE MDT or QoE configuration. The communication manager 140 may transmit or may cause the transmission component 604 to transmit, in accordance with the MAC-CE MDT or QoE configuration, a MAC-CE carrying one or more MDT or QoE measurements. In some aspects, the communication manager 140 may perform one or more operations described elsewhere herein as being performed by one or more components of the communication manager 140. The communication manager 140 may include one or more controllers/processors and/or one or more memories of the UE described above in connection with FIG. 2.

The transmission component 604 may transmit a UE capability indicating that the UE is capable of carrying MDT or QoE measurements in MAC-CEs. The reception component 602 may receive, in accordance with the UE capability, a MAC-CE MDT or QoE configuration. The transmission component 604 may transmit, in accordance with the MAC-CE MDT or QoE configuration, a MAC-CE carrying one or more MDT or QoE measurements. In some aspects, the transmission component 604 may transmit, in accordance with an uplink grant not being associated with the MAC-CE carrying the one or more MDT or QoE measurements, an SR associated with the MAC-CE carrying the one or more MDT or QoE measurements. In some aspects, the reception component 602 may receive, via another MAC-CE or PDCCH DCI, a request for the MAC-CE carrying the one or more MDT or QoE measurements.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally or alternatively, a set of (one or more) components shown in FIG. 6 may perform one or more functions described as being performed by another set of components shown in FIG. 6.

FIG. 7 is a diagram of an example apparatus 700 for wireless communication that supports MAC-CEs for MDT or QoE. The apparatus 700 may be a network node, or a network node may include the apparatus 700. In some aspects, the apparatus 700 includes a reception component 702, a transmission component 704, and a communication manager 150, which may be in communication with one another (for example, via one or more buses). As shown, the apparatus 700 may communicate with another apparatus 706 (such as a UE, a network node, or another wireless communication device) using the reception component 702 and the transmission component 704.

In some aspects, the apparatus 700 may be configured to and/or operable to perform one or more operations described herein in connection with FIG. 3. Additionally or alternatively, the apparatus 700 may be configured to and/or operable to perform one or more processes described herein, such as process 500 of FIG. 5. In some aspects, the apparatus 700 may include one or more components of the network node described above in connection with FIG. 2.

The reception component 702 may receive communications, such as reference signals, control information, and/or data communications, from the apparatus 706. The reception component 702 may provide received communications to one or more other components of the apparatus 700, such as the communication manager 150. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, one or more modems, one or more demodulators, one or more MIMO detectors, one or more receive processors, one or more controllers/processors, and/or one or more memories of the network node described above in connection with FIG. 2.

The transmission component 704 may transmit communications, such as reference signals, control information, and/or data communications, to the apparatus 706. In some aspects, the communication manager 150 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 704 may be co-located with the reception component 702 in one or more transceivers.

The communication manager 150 may receive or may cause the reception component 702 to receive a UE capability indicating that a UE is capable of carrying MDT or QoE measurements in MAC-CEs. The communication manager 150 may transmit or may cause the transmission component 704 to transmit, in accordance with the UE capability, a MAC-CE MDT or QoE configuration. The communication manager 150 may receive or may cause the reception component 702 to receive, in accordance with the MAC-CE MDT or QoE configuration, a MAC-CE carrying one or more MDT or QoE measurements. In some aspects, the communication manager 150 may perform one or more operations described elsewhere herein as being performed by one or more components of the communication manager 150. The communication manager 150 may include one or more controllers/processors, one or more memories, one or more schedulers, and/or one or more communication units of the network node described above in connection with FIG. 2.

The reception component 702 may receive a UE capability indicating that a UE is capable of carrying MDT or QoE measurements in MAC-CEs. The transmission component 704 may transmit, in accordance with the UE capability, a MAC-CE MDT or QoE configuration. The reception component 702 may receive, in accordance with the MAC-CE MDT or QoE configuration, a MAC-CE carrying one or more MDT or QoE measurements. In some aspects, the reception component 702 may receive, in accordance with an uplink grant not being associated with the MAC-CE carrying the one or more MDT or QoE measurements, an SR associated with the MAC-CE carrying the one or more MDT or QoE measurements. In some aspects, the transmission component 704 may transmit, via another MAC-CE or PDCCH DCI, a request for the MAC-CE carrying the one or more MDT or QoE measurements.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a user equipment (UE), comprising: transmitting a UE capability indicating that the UE is capable of carrying minimization of drive test (MDT) or quality of experience (QoE) measurements in medium access control (MAC) control elements (MAC-CEs); receiving, in accordance with the UE capability, a MAC-CE MDT or QoE configuration; and transmitting, in accordance with the MAC-CE MDT or QoE configuration, a MAC-CE carrying one or more MDT or QoE measurements.
Aspect 2: The method of Aspect 1, wherein the MAC-CE MDT or QoE configuration indicates one or more triggering condition parameters associated with the MAC-CE carrying the one or more MDT or QoE measurements.
Aspect 3: The method of Aspect 2, wherein the one or more triggering condition parameters include a physical downlink shared channel (PDSCH) discard rate threshold associated with one or more hybrid automatic repeat request (HARQ) acknowledgment (ACK) or negative ACK (NACK) feedback errors.
Aspect 4: The method of Aspect 2, wherein the one or more triggering condition parameters include a MAC padding threshold.
Aspect 5: The method of Aspect 2, wherein the one or more triggering condition parameters include a data stall threshold.
Aspect 6: The method of Aspect 2, wherein the one or more triggering condition parameters include a QoE threshold associated with an application.
Aspect 7: The method of any of Aspects 1-6, further comprising: transmitting, in accordance with an uplink grant not being associated with the MAC-CE carrying the one or more MDT or QoE measurements, a scheduling request (SR) associated with the MAC-CE carrying the one or more MDT or QoE measurements.
Aspect 8: The method of any of Aspects 1-7, further comprising: receiving, via another MAC-CE or PDCCH DCI, a request for the MAC-CE carrying the one or more MDT or QoE measurements.
Aspect 9: The method of any of Aspects 1-8, wherein the MAC-CE further carries an indication of one or more candidate root causes associated with the one or more MDT or QoE measurements.
Aspect 10: The method of any of Aspects 1-9, wherein the MAC-CE further carries an indication of a resolution time associated with the one or more MDT or QoE measurements.
Aspect 11: The method of any of Aspects 1-10, wherein the MAC-CE further carries an indication of one or more candidate actions associated with the one or more MDT or QoE measurements.
Aspect 12: A method of wireless communication performed by a network node, comprising: receiving a user equipment (UE) capability indicating that a UE is capable of carrying minimization of drive test (MDT) or quality of experience (QoE) measurements in medium access control (MAC) control elements (MAC-CEs); transmitting, in accordance with the UE capability, a MAC-CE MDT or QoE configuration; and receiving, in accordance with the MAC-CE MDT or QoE configuration, a MAC-CE carrying one or more MDT or QoE measurements.
Aspect 13: The method of Aspect 12, wherein the MAC-CE MDT or QoE configuration indicates one or more triggering condition parameters associated with the MAC-CE carrying the one or more MDT or QoE measurements.
Aspect 14: The method of Aspect 13, wherein the one or more triggering condition parameters include a physical downlink shared channel (PDSCH) discard rate threshold associated with one or more hybrid automatic repeat request (HARQ) acknowledgment (ACK) or negative ACK (NACK) feedback errors.
Aspect 15: The method of Aspect 13, wherein the one or more triggering condition parameters include a MAC padding threshold.
Aspect 16: The method of Aspect 13, wherein the one or more triggering condition parameters include a data stall threshold.
Aspect 17: The method of Aspect 13, wherein the one or more triggering condition parameters include a QoE threshold associated with an application.
Aspect 18: The method of any of Aspects 12-17, further comprising: receiving, in accordance with an uplink grant not being associated with the MAC-CE carrying the one or more MDT or QoE measurements, a scheduling request (SR) associated with the MAC-CE carrying the one or more MDT or QoE measurements.
Aspect 19: The method of any of Aspects 12-18, further comprising: receiving, via another MAC-CE or PDCCH DCI, a request for the MAC-CE carrying the one or more MDT or QoE measurements.
Aspect 20: The method of any of Aspects 12-19, wherein the MAC-CE further carries an indication of one or more candidate root causes associated with the one or more MDT or QoE measurements.
Aspect 21: The method of any of Aspects 12-20, wherein the MAC-CE further carries an indication of a resolution time associated with the one or more MDT or QoE measurements.
Aspect 22: The method of any of Aspects 12-21, wherein the MAC-CE further carries an indication of one or more candidate actions associated with the one or more MDT or QoE measurements.
Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.
Aspect 24: An apparatus for wireless communication at a device, the apparatus comprising one or more memories and one or more processors coupled to the one or more memories, the one or more processors configured to cause the device to perform the method of one or more of Aspects 1-22.
Aspect 25: An apparatus for wireless communication, the apparatus comprising at least one means for performing the method of one or more of Aspects 1-22.
Aspect 26: A non-transitory computer-readable medium storing code for wireless communication, the code comprising instructions executable by one or more processors to perform the method of one or more of Aspects 1-22.
Aspect 27: A non-transitory computer-readable medium storing a set of instructions for wireless communication, the set of instructions comprising one or more instructions that, when executed by one or more processors of a device, cause the device to perform the method of one or more of Aspects 1-22.
Aspect 28: A device for wireless communication, the device comprising a processing system that includes one or more processors and one or more memories coupled with the one or more processors, the processing system configured to cause the device to perform the method of one or more of Aspects 1-22.
Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
transmit a UE capability indicating that the UE is capable of carrying minimization of drive test (MDT) or quality of experience (QoE) measurements in medium access control (MAC) control elements (MAC-CEs);
receive, in accordance with the UE capability, a MAC-CE MDT or QoE configuration; and
transmit, in accordance with the MAC-CE MDT or QoE configuration, a MAC-CE carrying one or more MDT or QoE measurements.

2. The apparatus of claim 1, wherein the MAC-CE MDT or QoE configuration indicates one or more triggering condition parameters associated with the MAC-CE carrying the one or more MDT or QoE measurements.

3. The apparatus of claim 2, wherein at least one processor of the one or more processors is configured to cause the UE to:
receive, via another MAC-CE or physical downlink control channel (PDCCH) downlink control information (DCI), a request for the MAC-CE carrying the one or more MDT or QoE measurements.

4. The apparatus of claim 2, wherein the one or more triggering condition parameters include a physical downlink shared channel (PDSCH) discard rate threshold associated with one or more hybrid automatic repeat request (HARQ) acknowledgment (ACK) or negative ACK (NACK) feedback errors.

5. The apparatus of claim 2, wherein the one or more triggering condition parameters include a MAC padding threshold.

6. The apparatus of claim 2, wherein the one or more triggering condition parameters include a data stall threshold.

7. The apparatus of claim 2, wherein the one or more triggering condition parameters include a QoE threshold associated with an application.

8. A method of wireless communication performed at a user equipment (UE), comprising:
transmitting a UE capability indicating that the UE is capable of carrying minimization of drive test (MDT) or quality of experience (QoE) measurements in medium access control (MAC) control elements (MAC-CEs);
receiving, in accordance with the UE capability, a MAC-CE MDT or QoE configuration; and
transmitting, in accordance with the MAC-CE MDT or QoE configuration, a MAC-CE carrying one or more MDT or QoE measurements.

9. The method of claim 8, further comprising:
transmitting, in accordance with an uplink grant not being associated with the MAC-CE carrying the one or more MDT or QoE measurements, a scheduling request (SR) associated with the MAC-CE carrying the one or more MDT or QoE measurements.

10. The method of claim 8, further comprising:
receiving, via another MAC-CE or physical downlink control channel (PDCCH) downlink control information (DCI), a request for the MAC-CE carrying the one or more MDT or QoE measurements.

11. The method of claim 8, wherein the MAC-CE further carries an indication of one or more candidate root causes associated with the one or more MDT or QoE measurements.

12. The method of claim 8, wherein the MAC-CE further carries an indication of a resolution time associated with the one or more MDT or QoE measurements.

13. The method of claim 8, wherein the MAC-CE further carries an indication of one or more candidate actions associated with the one or more MDT or QoE measurements.

14. An apparatus for wireless communication at a network node, comprising:
one or more memories storing processor-executable code; and
one or more processors coupled with the one or more memories, at least one processor of the one or more processors configured to cause the network node to:
receive a user equipment (UE) capability indicating that a UE is capable of carrying minimization of drive test (MDT) or quality of experience (QoE) measurements in medium access control (MAC) control elements (MAC-CEs);
transmit, in accordance with the UE capability, a MAC-CE MDT or QoE configuration; and
receive, in accordance with the MAC-CE MDT or QoE configuration, a MAC-CE carrying one or more MDT or QoE measurements.

15. The apparatus of claim 14, wherein the MAC-CE MDT or QoE configuration indicates one or more triggering condition parameters associated with the MAC-CE carrying the one or more MDT or QoE measurements.

16. The apparatus of claim 14, wherein at least one processor of the one or more processors is configured to cause the network node to:
receive, in accordance with an uplink grant not being associated with the MAC-CE carrying the one or more MDT or QoE measurements, a scheduling request (SR) associated with the MAC-CE carrying the one or more MDT or QoE measurements.

17. The apparatus of claim 14, wherein at least one processor of the one or more processors is configured to cause the network node to:
transmit, via another MAC-CE or physical downlink control channel (PDCCH) downlink control information (DCI), a request for the MAC-CE carrying the one or more MDT or QoE measurements.

18. The apparatus of claim 14, wherein the MAC-CE further carries an indication of one or more candidate root causes associated with the one or more MDT or QoE measurements.

19. The apparatus of claim 14, wherein the MAC-CE further carries an indication of a resolution time associated with the one or more MDT or QoE measurements.

20. The apparatus of claim 14, wherein the MAC-CE further carries an indication of one or more candidate actions associated with the one or more MDT or QoE measurements.
